(19) United States
(12) Patent Application Publication
(10) Pub. No.: US 2012/0078860 A1
(43) Pub. Date: Mar. 29, 2012

(54) ALGORITHMIC COMPRESSION VIA USER-DEFINED FUNCTIONS

(75) Inventors: Gary Roberts, Carlsbad, CA (US); Venkata Ramakrishna Tirunagari, Hyderabad (IN); Harish Ramachandran, Bangalore (IN); Frederick Kaufmann, Irvine, CA (US); Aikyatha Kamalakar, El Segundo, CA (US); Mark Hodgens, San Diego, CA (US); Donald Pederson, San Diego, CA (US)

(73) Assignee: TERADATA US, INC., Miamisburg, OH (US)

(21) Appl. No.: 12/944,185

(22) Filed: Nov. 11, 2010

Related U.S. Application Data
(60) Provisional application No. 61/387,874, filed on Sep. 29, 2010.

(51) Int. Cl. G06F 17/00

(52) U.S. Cl. 707/693; 707/E17.007

(57) ABSTRACT

A method, apparatus, and article of manufacture for accessing data in a computer system. One or more user-defined functions (UDFs) implementing a desired compression or decompression algorithm are created, wherein the UDFs are associated with one or more columns of a table when the table is created or altered, in order to perform compression or decompression of data stored in the associated columns, such that the data is compressed by the UDF implementing the desired compression algorithm when the data is inserted or updated in the table, and the data is decompressed by the UDF implementing the desired decompression algorithm when the data is retrieved from the table.

### CROSS REFERENCE TO RELATED APPLICATIONS

This application claims the benefit under 35 U.S.C. Section 119(e) of co-pending and commonly-assigned U.S. Provisional Patent Application Ser. No. 61/387,874, filed on Sep. 29, 2010, by Gary A. Roberts, Tirunagari V. Ramakrishna, Harish Ramachandran, Frederick S. Kaufmann, Aikyatha K. Patil, Mark A. Hodgens, and Donald R. Pederson, entitled “ALGORITHMIC COMPRESSION VIA USER-DEFINED FUNCTIONS,” attorneys' docket number 20559 (30145.481-US-P1), which application is incorporated by reference herein.

### BACKGROUND OF THE INVENTION

1. Field of the Invention

This invention relates in general to database management systems performed by computers, and in particular, to algorithmic compression via user-defined functions.

2. Description of Related Art

The ability to manage massive amounts of information has become a necessity for business today. With the advent of data warehouses, it is not uncommon for databases to store very large tables that comprise gigabytes, terabytes, petabytes or more, because businesses are retaining enormous amounts of data and then mining it to identify business value. Regulatory and legal retention requirements are also leading businesses to keep years of historical data accessible to data warehouses.

Compression is used to reduce storage cost by storing more logical data per unit of physical capacity. Performance may be improved as well, because there is less physical data to retrieve from data storage devices. Performance may be further enhanced since data can remain compressed while cached in memory. Consequently, there are many benefits to the use of compression in data warehouses.

A problem arises, however, in that most data warehouses offer only a single or few types of compression. Generally, different types of data require different types of compression for optimal performance. Consequently, most data types are not optimally compressed in most data warehouses.

While there have been various methods developed for compressing and decompressing data stored in databases, there is a need in the art for techniques that optimize of compressing and decompressing the data stored in databases by offering many different types of compression.

### SUMMARY OF THE INVENTION

To overcome the limitations in the prior art described above, and to overcome other limitations that will become apparent upon reading and understanding the present specification, the present invention discloses a computer-implemented method, apparatus, and article of manufacture for accessing data in a computer system.

Specifically, one or more user-defined functions (UDFs) implementing a desired compression or decompression algorithm are created, wherein the UDFs are associated with one or more columns of a table when the table is created or altered, in order to perform compression or decompression of data stored in the associated columns. The data is compressed by the UDF implementing the desired compression algorithm when the data is inserted or updated in the table, and the data is decompressed by the UDF implementing the desired decompression algorithm when the data is retrieved from the table.

There may be a plurality of different UDFs implementing a plurality of different compression and decompression algorithms for a plurality of different types of data. The different UDFs may be associated with different columns of the table, or a single UDF may be associated with different columns of the table.

### BRIEF DESCRIPTION OF THE DRAWINGS

Referring now to the drawings in which like reference numbers represent corresponding parts throughout:

FIG. 1 illustrates an exemplary software and hardware environment that could be used with the present invention;

FIG. 2 is a flow chart illustrating the steps necessary for the interpretation and execution of queries or other user interactions, either in a batch environment or in an interactive environment, according to the preferred embodiment of the present invention; and

FIG. 3 is a flow chart illustrating the steps performed when using the algorithmic compression technique of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Environment

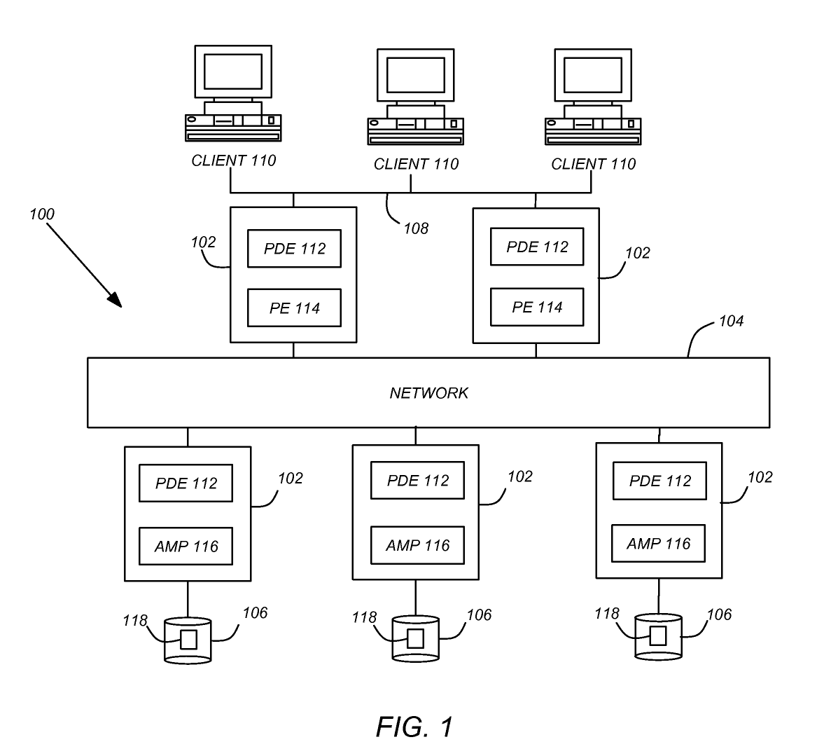

FIG. 1 illustrates an exemplary hardware and software environment that could be used with the present invention. In the exemplary environment, a computer system 100 is comprised of one or more processing units (PUs) 102, also known as processors or nodes, which are interconnected by a network 104. Each of the PUs 102 is coupled to zero or more fixed and/or removable data storage units (DSUs) 106, such as disk drives, that store one or more relational databases. Further, each of the PUs 102 is coupled to zero or more data communications units (DCUs) 108, such as network interfaces, that communicate with one or more remote systems or devices.

Operators of the computer system 100 typically use a workstation 110, terminal, computer, or other input device to interact with the computer system 100. This interaction generally comprises requests or statements that conform to the Structured Query Language (SQL) standard, and invoke functions performed by Relational DataBase Management System (RDBMS) software executed by the system 100.

Specifically, the RDBMS software manages data stored as one or more tables in a relational database, wherein a table is two dimensional, comprising rows (tuples) and columns (attributes). Generally, each column is defined by a schema that defines the type of data held in that column. SQL statements may be used to interact with and manipulate the data stored in the tables, including inserting or updating the data and retrieving the data.

In the preferred embodiment of the present invention, the RDBMS software comprises the Teradata® product offered by Teradata Corporation, and includes one or more Parallel Database Extensions (PDEs) 112, Parsing Engines (PEs) 114, and Access Module Processors (AMPs) 116. These components of the RDBMS software perform the functions necessary to implement the RDBMS and SQL, i.e., definition, compilation, interpretation, optimization, database access control, database retrieval, database update, etc.

Work is divided among the PUs 102 in the system 100 by spreading the storage of a partitioned relational database 118 managed by the RDBMS software across multiple AMPs 116 and the DSUs 106 (which are managed by the AMPs 116). Thus, a DSU 106 may store only a subset of rows that comprise a table in the partitioned database 118 and work is managed by the system 100 so that the task of operating on each subset of rows is performed by the AMP 116 managing the DSUs 106 that store the subset of rows.

The PEs 114 handle communications, session control, optimization and query plan generation and control. The PEs 114 fully parallelize all functions among the AMPs 116. As a result, the system of FIG. 1 applies a multiple instruction stream, multiple data stream (MIMD) concurrent processing architecture to implement a relational database management system 100.

Generally, the PDEs 112, PEs 114, and AMPs 116 are tangibly embodied in and/or accessible from a device, media, carrier, etc., such as RAM, ROM, one or more of the DSUs 106, and/or a remote system or device communicating with the computer system 100 via one or more of the DCUs 108. The PDEs 112, PEs 114, and AMPs 116 each comprise instructions and/or data which, when executed, invoked, and/or interpreted by the PUs 102 of the computer system 100, cause the necessary steps or elements of the present invention to be performed.

Those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Execution of SQL Statements

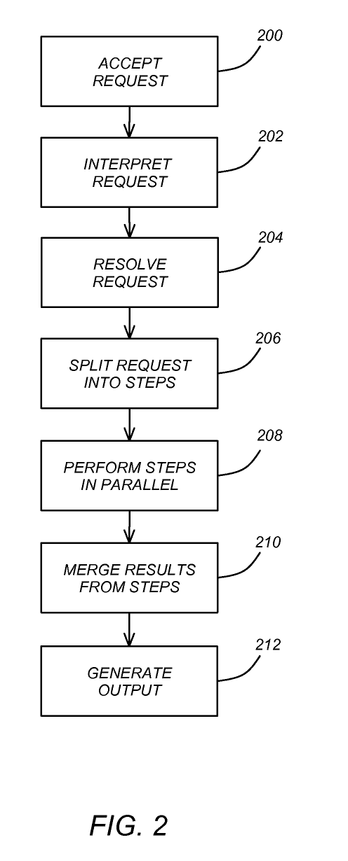

FIG. 2 is a flow chart illustrating the steps performed by the system 100 for the interpretation and execution of user requests or other interactions, either in a batch environment or in an interactive environment, according to the preferred embodiment of the present invention.

Block 200 represents a request comprising one or more SQL statements being accepted by the PE 114.

Block 202 represents the request being transformed by an interpreter function of the PE 114.

Block 204 represents the PE 114 resolving symbolic names in the request using a data dictionary that contains information about the relational database 118, including the tables and columns in the relational database 118.

Block 206 represents the PE 114 splitting the request into one or more “step messages”, wherein each step message is assigned to an AMP 116 that manages the desired rows. As noted above, the rows of the tables in the database 118 may be partitioned or otherwise distributed among multiple AMPs 116, so that multiple AMPs 116 can work at the same time on the data of a given table. If a request is for data in a single row, the PE 114 transmits the steps to the AMP 116 in which the data resides. If the request is for multiple rows, then the steps are forwarded to all participating AMPs 116. Since the tables in the database 118 may be partitioned or distributed across the DSUs 16 of the AMPs 116, the workload of performing the request can be balanced among AMPs 116 and DSUs 16.

Block 206 also represents the PE 114 sending the step messages to their assigned AMPs 116.

Block 208 represents the AMPs 116 performing the required data manipulation associated with the step messages received from the PE 114, and then transmitting appropriate responses back to the PE 114.

Block 210 represents the PE 114 then merging the responses that come from the AMPs 116.

Block 212 represents the output or result table being generated.

### Algorithmic Compression of Data

In view of the vast amounts of data and types of data that are now being stored in databases, there is a need for improved data compression functions within the RDBMS. Specifically, there is a need for different types of data compression to be used on different types of data stored within the RDBMS. However, the prior art typically provides only one or a few types of data compression in the RDBMS.

For example, there are many ways to compress character data, such as value list compression (VLC), which is offered by Teradata Corporation, the assignee of the present invention. At the column level, this compression allows a user to compress certain fixed-length character values specified by the user. However, there is a limit to the number of values that can be compressed. Typically, a user will apply VLC using Pareto's principle, which says that a few (20%) values account for most of the occurrences (80%). VLC is a fine compression scheme, but it is limited not only by the number of values that can be compressed, but also by its flexibility.

In a typical RDBMS, on the other hand, there is a need for users to be able to compress data using compression algorithms of their choosing and to use different compression algorithms for different columns having different types of data. This allows users to choose compression algorithms that will potentially compress all their data, so that they can tailor the compression algorithms on a column-by-column basis, as well as avoid the numerical and flexibility issues of limited compression choices.

To solve these problems, the present invention provides for Algorithmic Compression (ALC) of data stored in the RDBMS. With the present invention, users can specify different compression and decompression algorithms for different types of data using SQL statements to specify and attach particular user-defined functions (UDFs) to particular columns in tables.

Specifically, each compression algorithm is implemented as a UDF (and its associated decompression algorithm is also implemented as a UDF), which means that there can be any number of different compression and decompression algorithms available for use in the RDBMS. The compression and decompression UDFs are then associated with a particular column in a table via the use of CREATE TABLE or ALTER TABLE commands in an SQL statement. Thereafter, data is compressed by the UDF implementing the desired compression algorithm when inserted or updated in the table, and the data is decompressed by the UDF implementing the desired decompression algorithm when retrieved from the table.

For example, the following SQL statement illustrates how compression and decompression UDFs are associated with a particular column in a table using the CREATE TABLE command:

| | |
|---|---|
| CREATE TABLE tab1 ( | col1 INTEGER, |
| | col2 VARCHAR (100) |

COMPRESS USING compalg1
DECOMPRESS USING decompalg1);

In this example, “tab1” is the table name, “col1” is a first column of the table having an integer data type (as indicated by the INTEGER mnemonic) and “col2” is a second column of the table having a variable character data type with a maximum of 100 characters (as indicated by the VARCHAR (100) mnemonic), “compalg1” is the name of a UDF implementing a desired compression algorithm on “col2” (as indicated by the COMPRESS USING mnemonic), and “decompalg2” is the name of a UDF implementing a corresponding desired decompression algorithm on “col2” (as indicated by the DECOMPRESS USING mnemonic).

Note that many different UDFs may be created and specified, meaning that many different compression and decompression algorithms may be used and specified. Moreover, any number of columns can be compressed and decompressed using this technique, so long as valid UDFs are specified on those columns.

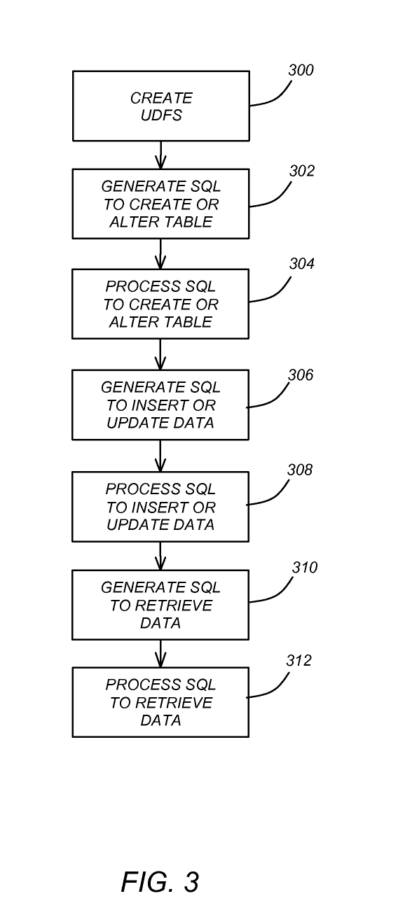

FIG. 3 is a flow chart illustrating the steps performed by the system 100 when using the algorithmic compression technique, according to the preferred embodiment of the present invention.

Block 300 represents one or more UDFs being created implementing the desired compression and decompression algorithms. These UDFs are then associated with one or more columns of a table when the table is created or altered, in order to perform compression or decompression of data stored in the associated columns. The data is compressed by the UDF implementing the desired compression algorithm when the data is inserted or updated in the table, and the data is decompressed by the UDF implementing the desired decompression algorithm when the data is retrieved from the table.

Preferably, the UDFs, when stored in the RDBMS, include identifiers that designate the UDFs as being UDFs that perform compression or decompression. For example, the UDFs may be stored with FOR COMPRESS or FOR DECOMPRESS options that designate these UDFs as being UDFs that perform the desired compression or decompression algorithms.

Block 302 represents one or more SQL statements being generated that include CREATE TABLE or ALTER TABLE commands for a table. The UDFs implementing the desired compression or decompression algorithms are identified in the statements, wherein the UDF implementing a desired compression algorithm is identified for one or more columns of the table (for example, as indicated by the COMPRESS USING mnemonic), and the UDF implementing a corresponding desired decompression algorithm is also identified for one or more columns of the table (for example, as indicated by the DECOMPRESS USING mnemonic).

Block 304 represents the RDBMS processing the SQL statements of Block 302, and creating or altering one or more tables stored in the relational database 118 managed by the RDBMS. As noted above, one or more UDFs implementing a desired compression or decompression algorithm are associated with one or more columns of the table, in order to perform compression or decompression of data stored in the associated columns when the data is inserted or updated in the table or retrieved from the table.

Block 306 represents one or more SQL statements being generated that include commands to insert or update data in a table.

Block 308 represents the RDBMS processing the SQL statements of Block 306, and inserting or updating data stored in one or more columns of a table stored in the relational database 118 managed by the RDBMS. As noted above, the UDFs implementing a desired compression or decompression algorithm are associated with the columns of the table, in order to perform compression of the data stored in the associated columns, such that the data is compressed by the UDF implementing the desired compression algorithm when the data is inserted or updated in the table. Specifically, the UDF implementing the desired compression algorithm is invoked when the statements are processed, resulting in the data being compressed by the UDF before it is inserted or updated in the table.

Block 310 represents one or more SQL statements being generated that include commands to retrieve data from a table.

Block 312 represents the RDBMS processing the SQL statements of Block 310, and retrieving data stored in one or more columns of a table stored in the relational database 118 managed by the RDBMS. As noted above, the UDFs implementing a desired compression or decompression algorithm are associated with the columns of the table, in order to perform decompression of the data stored in the associated columns, such that the data is decompressed by the UDF implementing the desired decompression algorithm when the data is retrieved from the table. Specifically, the UDF implementing the desired decompression algorithm is invoked when the statements are processed, resulting in the data being decompressed by the UDF after it is retrieved from the table and before it is presented to a user or otherwise processed.

Note that there may be a plurality of different UDFs implementing a plurality of different compression and decompression algorithms for a plurality of different types of data. As a result, there may be different UDFs associated with different columns of a table. Alternatively, there may be a single UDF associated with different columns of a table.

UDFs can be supplied from many sources. As the name infers, users can create UDFs, which is important because UDFs are often application-specific. UDFs can also be supplied by vendors and third parties.

The UDFs implementing the compression and decompression algorithms need to invoke certain function calls in the RDBMS to allow the UDFs to know: the output buffer size, and the byte, character, graphic and VarChar lengths. These functions allow the UDF to correctly determine the UDF input and output parameters. This insures that the UDF input parameter has the same number of characters as the column definition. For example, the compress and decompress UDFs might be defined with default VarChar (64000) and VarByte (64000) input and return parameters. However, these UDFs could be defined on a Char (100) column. In that case, the function calls ensure that the UDFs are invoked with parameter lengths of 100 and not 64,000.

Note also that, depending on the compression algorithm used, it is possibly for the compressed data to be larger than the original data. For example, a Unicode string compressed to UTF8 format could end up being larger than the original Unicode string. In this situation, the data may not be compressed by the UDF implementing the compression algorithm, or decompressed by the UDF implementing the decompression algorithm, and instead may be stored in its original form in the relational database 118. Preferably, the RDBMS will indicate that compression was not applied, notwithstanding that the column is marked or tagged for compression, and the UDFs will understand this as well.

In summary, the present invention is significant because it provides a flexible, yet easy-to-use, user-driven solution to the difficult problem of compression. This solution provides a compression/decompression framework within the RDBMS, while a user, vendor or third party provides the specific solution. UDFs can be created using well-known algorithms or newly created algorithms, and these different algorithms can be applied to different columns of the same table.

### CONCLUSION

This concludes the description of the preferred embodiment of the invention. The following paragraphs describe some alternative embodiments for accomplishing the same invention. For example, any type of computer, such as a mainframe, minicomputer, or personal computer, could be used to implement the present invention. In addition, any DBMS or other program that performs similar functions could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for accessing data in a computer system, comprising:
creating one or more user-defined functions (UDFs) implementing a desired compression or decompression algorithm in the computer system;
wherein the UDFs are associated with one or more columns of a table stored in a database managed by a database management system executed by the computer system, in order to perform compression or decompression of data stored in the associated columns when the data is inserted or updated in the table or retrieved from the table.

2. A method for accessing data in a computer system, comprising:
creating or altering one or more tables stored in a database managed by a database management system executed by the computer system;
wherein one or more user-defined functions (UDFs) implementing a desired compression or decompression algorithm are associated with one or more columns of the table, in order to perform compression or decompression of data stored in the associated columns when the data is inserted or updated in the table or retrieved from the table.

3. A method for accessing data in a computer system, comprising:
inserting, updating or retrieving data stored in one or more columns of a table stored in a database managed by a database management system executed by the computer system;
wherein one or more user-defined functions (UDFs) implementing a desired compression or decompression algorithm are associated with the columns of the table, in order to perform compression or decompression of the data stored in the associated columns, such that the data is compressed by the UDF implementing the desired compression algorithm when the data is inserted or updated in the table, and the data is decompressed by the UDF implementing the desired decompression algorithm when the data is retrieved from the table.

4. The method of claim 1, 2 or 3, wherein there are a plurality of different UDFs implementing a plurality of different compression and decompression algorithms for a plurality of different types of data.

5. The method of claim 1, 2, or 3, wherein there are different UDFs associated with different columns of the table.

6. The method of claim 1, 2, or 3, wherein there is a single UDF associated with different columns of the table.

7. The method of claim 1, wherein the UDFs, when stored in the computer system, include identifiers that designate the UDFs as being UDFs that perform compression or decompression.

8. The method of claim 2, wherein the table is created or altered by processing one or more statements in the computer system, and the UDFs implementing the desired compression or decompression algorithms are identified in the statements.

9. The method of claim 3, wherein the data is inserted or updated in the table by processing one or more statements in the computer system, and the UDF implementing the desired compression algorithm is invoked when the statements are processed, resulting in the data being compressed by the UDF before it is inserted or updated in the table.

10. The method of claim 3, wherein the data is retrieved from the table by processing one or more statements in the computer system, and the UDF implementing the desired decompression algorithm is invoked when the statements are processed, resulting in the data being decompressed by the UDF after it is retrieved from the table and before it is presented to a user or otherwise processed.

11. An apparatus for accessing data, comprising:
a computer system that performs one or more user-defined functions (UDFs) implementing a desired compression or decompression algorithm;
wherein the UDFs are associated with one or more columns of a table stored in a database managed by a database management system executed by the computer system, in order to perform compression or decompression of data stored in the associated columns when the data is inserted or updated in the table or retrieved from the table.

12. An article of manufacture comprising a program storage device embodying one or more instructions that, when executed by a computer system, perform a method for accessing data, the method comprising:
performing one or more user-defined functions (UDFs) implementing a desired compression or decompression algorithm in the computer system;
wherein the UDFs are associated with one or more columns of a table stored in a database managed by a database management system executed by the computer system, in order to perform compression or decompression of data stored in the associated columns when the data is inserted or updated in the table or retrieved from the table.
